(19) United States
(12) Patent Application Publication
(10) Pub. No.: US 2013/0337342 A1
(43) Pub. Date: Dec. 19, 2013

(54) Electrolyte Formulation for High Voltage and Wide Temperature Lithium-Ion Cells

(71) Applicants: Peter B. Hallac, Franklin, WI (US); Junwei Jiang, Glendale, WI (US); Christopher R. Fell, Milwaukee, WI (US)

(72) Inventors: Peter B. Hallac, Franklin, WI (US); Junwei Jiang, Glendale, WI (US); Christopher R. Fell, Milwaukee, WI (US)

(21) Appl. No.: 13/910,686

(22) Filed: Jun. 5, 2013

Related U.S. Application Data
(60) Provisional application No. 61/656,419, filed on Jun. 6, 2012.

(51) Int. Cl. H01M 10/056; H01M 10/0525; H01M 4/131

(52) U.S. Cl. CPC H01M 10/056; H01M 4/131; H01M 10/0525
USPC 429/331; 429/188; 429/199; 429/200; 429/326; 429/342; 429/338; 429/332

(57) ABSTRACT

An electrochemical cell provided with a positive electrode, a negative electrode, and an electrolyte. The positive electrode comprises a stabilized lithium metal oxide material, the lithium metal oxide material comprising one or more transition metal ions. The electrolyte is prepared by mixing ingredients comprising a solvent, a lithium salt, and a sultone.

### CROSS-REFERENCE TO RELATED APPLICATIONS

This application claims the benefit of U.S. Provisional Application No. 61/656,419 entitled “Electrolyte formulation for high voltage and wide temperature lithium-ion cells” filed Jun. 6, 2012, which is incorporated by reference in its entirety.

### BACKGROUND

Layered lithium metal oxide cathode materials represented by formula xLiMO₂.(1-x)Li₂MnO₃ where the M in LiMO₂ includes one or more Ni, Mn, Co, or any transition metal, are promising materials for lithium ion batteries since they are characterized by high specific capacities when operated at high voltages. Compared to conventional layered metal oxides which usually operate at voltages less than 4.3 V vs. Li⁺/Li⁰ (that is, as measured against a lithium metal electrode Li⁺/Li⁰), such cathode materials can reach specific capacities within the range of 170 to 250 mAh/g; this is 13-70% higher to conventional layered metal oxides. However, due to its reactivity with electrolyte solvents, the layered cathode material's cycling performance and rate capability can be compromised, resulting in a high impedance of surface and bulk. This creates a need for electrolyte formulations with additives that can protect the cathode surface and thus hinder the electrode-electrolyte reaction that is adverse to cell performance.

The performance of a lithium-ion cell at voltages over 4.3 V is highly dependent upon the stability of the electrolyte. Since the primary solvents in the electrolyte are cyclic and linear carbonates, their oxidative reactions with the cathode surface can lead to irreversible losses and severe capacity fading. Such reactions are usually limited by either replacing those solvents with more stable ones that can be fluorinated, or by using additives that can form a protective layer on the oxidized electrode surface.

### SUMMARY

In a first aspect, an electrochemical cell is provided. The cell includes a positive electrode, a negative electrode, and an electrolyte. The positive electrode comprises a stabilized lithium metal oxide material, the lithium metal oxide material comprising one or more transition metal ions. The electrolyte is prepared by mixing ingredients comprising a solvent, a lithium salt, and a sultone.

In a second aspect, an electrochemical cell is provided. The cell includes a positive electrode, a negative electrode, and an electrolyte. The positive electrode comprises a material represented by formula LiMO₂, where M includes one or more transition metal ions. The electrolyte is prepared by mixing ingredients comprising a solvent, a lithium salt, and a sultone.

### DEFINITIONS

As intended herein, the terms “a” and “an” include singular as well as plural references unless the context clearly dictates otherwise. For example, the term “a lithium metal oxide” can include one or more such oxides.

As intended herein, the terms “approximately” and “about” and similar terms have a broad meaning in harmony with the common and accepted usage in the art to which the subject matter of this disclosure pertains.

The term “ion”, when referring to the ion(s) of an element, indicates different oxidation states of the element depending on the specific circumstances. For example, an ion of the element manganese, or “Mn ion”, may be trivalent Mn, also known as Mn(III), in salts such as LiMnO₂, or tetravalent Mn, also known as Mn(IV), in salts such as Li₂MnO₃.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 illustrates a voltage profile of an electrode comprising LiMO₂.Li₂MnO₃ in the presence 1 wt % of propane sultone as electrolyte additive in a baseline electrolyte prepared by dissolving 1 M LiPF₆ in a 1:1 (vol/vol) mixture of ethyl carbonate and ethyl methyl carbonate.

FIG. 2 illustrates the cycle performance of an electrode comprising LiMO₂.Li₂MnO₃ in a half cell. Comparison is shown for two electrolytes: baseline (♦) and baseline with 1 wt % propane sultone (▴). The cell was cycled at 0.2C rate and at 23° C. and within the voltage window of 2-4.6 V.

FIG. 3 illustrates the cycle performance of a full cell having a Graphite/LiMO₂.Li₂MnO₃ electrode couple. The cell is cycled at different rates of charge/discharge at 23° C.

FIG. 4 illustrates the cycle performance of a full cell having a Graphite/LiMO₂.Li₂MnO₃ couple. The cell was cycled at the temperatures of 23° C. (♦) and 55° C. (□) at 1C/1C (charge/discharge) rates.

FIG. 5 illustrates the cycle performance of full cells having Graphite/LiMO₂.Li₂MnO₃ couple and different electrolyte formulations. The cells were cycled at 55° C., the electrolyte containing 1 wt % propane sultone (♦), or 1 wt % propane sultone and 0.5 wt % LiTFSI (□) at 1C/1C (charge/discharge) rates.

FIG. 6 illustrates the cycle performance of full cells having Graphite/NMC electrode couple and an electrolyte formulation including VC, LiBOB and PS as additives at 1C/1C (charge/discharge) rates and at 30° C. The voltage window is 3-4.3 V.

FIG. 7 is a cross-sectional view of an example lithium ion battery.

### DETAILED DESCRIPTION

Sultones prevent losses in cycling performance and rate capability in lithium-ion electrochemical cells operating at high voltages, such as cells with lithium metal oxide cathode materials typically operating at voltages exceeding 4.3 V vs. Li⁺/Li⁰. Without wishing to be bound to any particular theory, it is believed that, when present as additives in the cell electrolyte, sultone additives give rise to a protective layer on the oxidized positive electrode surface; this layer is believed to preserve nonaqueous electrolyte solvents, such as linear and cyclic carbonates, which would otherwise undergo oxidative reactions when in contact with cathodes operating at the above voltages.

The sultone additives find use in lithium ion electrochemical cells. In a first aspect, the cell cathode includes a material commonly known as a “stabilized metal oxide material”, where the metal includes one or more transition metal cations, for example as characterized in U.S. Pat. No. 6,677,082 to Thackeray et al. Such materials are represented, in their initial discharged state, by formula xLiMO₂.(1-x)Li₂M′O₃, alternatively Li₂₋ₓMₓM′₁₋ₓO₃₋ₓ, in which 0<x<1. Preferably, 0.8≦x<1, and more preferably 0.9≦x<1. In a set of representative embodiments, M is one or more ions having an average oxidation state of three with at least one ion being Mn, and M′ is one or more ions having an oxidation state of four and selected preferably from Mn, Ti, and Zr. In another set of embodiments, M is one or more ions having an average oxidation state of three with at least one ion being Ni, and M′ is one or more ions having an average oxidation state of four with at least one ion being Mn.

In a set of representative embodiments, the LiMO₂ component is essentially LiMnO₂. The transition metal and/or lithium ions may be partially replaced by minor concentrations (typically less than 10 atom percent) of other mono- or multivalent cations such as Al³⁺ or Mg²⁺ to impart improved structural stability or electronic conductivity to the electrode during electrochemical cycling. In addition, the xLiMO₂.(1-x)Li₂M′O₃ structures of the invention may include H⁺ ions, for example, resulting from the removal acidic H⁺ species from the electrolyte by ion-exchange with Li⁺ ions. Accordingly, the introduction of mono- or divalent cations into the stabilized LiMO₂ may occur, and the material of the electrode may depart slightly from the ideal stoichiometry as defined by the formula xLiMO₂.(1-x)Li₂M′O₃. Example embodiments where M′ is other than Mn, Ti, and Zr include compounds Li₂RuO₃, Li₂ReO₃, Li₂IrO₃, and Li₂PtO₃.

In a second aspect, sultone additives find use in electrochemical cells featuring traditional lithium ion oxide cathode materials represented by formula LiMO₂, where M includes one or more transition metals. Again without wishing to be bound to any particular theory, it is believed that, when such materials are charged at high voltages, e.g. potentials exceeding 4.3 V vs. Li/Li⁺, the formation of a protective layer on the cathode surface prevents the occurrence of oxidative reactions with the electrolyte solvent(s).

In some embodiments, the lithium ion oxide compound is an intercalation compound selected from the group consisting of ordered rocksalt compounds represented by formula LiMO₂, including those having the α-NaFeO₂ and orthorhombic-LiMnO₂ structure type or their derivatives of different crystal symmetry, atomic ordering, or partial substitution for the metals or oxygen, where M includes at least one first-row transition metal but may include non-transition metals including but not limited to Al, Ca, Mg, or Zr. In typical classes of lithium ion oxides, M represents one or more transition metals such as Sc, Ti, V, Co, Mn, Fe, Co, Ni, Cu, Zn, and Al. Lithium ion oxides commonly found in battery electrodes include lithium cobalt oxides (e.g. LiCoO₂), lithium nickel oxides (e.g. LiNiO₂), lithium manganese oxides (e.g. LMO spinel of formula LiMnO₂), lithium nickel manganese cobalt oxides (e.g. LiNi_{1/3}Mn_{1/3}Co_{1/3}O₂, also known as NMC), and other oxides comprising other metals partially substituting for Mn, Ni, and Co, such as LiNi_{0.80}Co_{0.15}Al_{0.05}O₂. Other representative oxides finding use in electrochemical cell electrodes include lithium nickel cobalt aluminum oxides, lithium titanates, lithium iron oxides, and lithium vanadium oxides.

Preferred solvents help the electrolytic solution to have a higher degree of dissociation of a lithium salt and to show satisfactory ionic conductivity. The protective effect conferred by sultone additives allows for the use of nonaqueous solvents that would otherwise undergo oxidative reactions when operating at the high cathodic voltages that may be reached with the above-described stabilized LiMO₂ materials. Example nonaqueous, organic solvents include carbonate compounds, ester compounds, ether compounds, ketone compounds, and combinations thereof. The carbonate compounds may include linear carbonate compounds, cyclic carbonate compounds, and combinations thereof. Example linear carbonate compounds include dimethyl carbonate (DMC), ethyl methyl carbonate (EMC), diethyl carbonate (DEC), dipropyl carbonate (DPC), methylpropyl carbonate (MPC), and ethylpropyl carbonate (EPC). Example cyclic carbonate compounds include ethylene carbonate (EC), propylene carbonate (PC), and butylene carbonate (BC). Representative ester solvents include propionates, butyrates, and acetates such as methyl acetate, ethyl acetate, and propyl acetate. Example ether solvents include tetrahydrofuran and 2-methyltetrahydrofuran, and example ketone solvents include cyclohexanone and polymethylvinylketone.

When linear carbonate compounds and cyclic carbonate compounds are mixed, an organic solvent having a high dielectric constant and low viscosity can be provided. The cyclic carbonate compounds and linear carbonate compounds may be mixed together at a volume ratio, for example, of about 1:1 to about 1:9. Examples of mixed organic solvents of linear carbonate compound and cyclic carbonate compound include a mixture including ethylene carbonate and ethyl methyl carbonate at a predetermined ratio. In some embodiments, one or more halogenated carbonate compounds may be added to further improve the performance of the electrolyte. For example, the halogenated carbonate compound may be fluoroethylene carbonate (FEC). The nonaqueous solvent may be included in a balance amount except for other components. In representative embodiments, the organic solvent may be included in an amount from about 1 to about 90 wt % based on the total weight of the electrolyte.

Non-limiting examples of lithium salts finding use in battery electrolytes include LiPF₆, LiBF₄, LiSbF₆, LiAsF₆, LiClO₄, LiCF₃SO₃, LiC₄F₉SO₃, LiSbF₆, LiAlO₄, LiAlCl₄, LiCl, LiI, or combinations thereof. In one embodiment, LiPF₆, LiBF₄, LiAsF₆, LiClO₄, CF₃SO₃Li, or combinations thereof may be used. LiPF₆ is particularly preferred for stable quality and for high ionic conductivity in carbonate solvents. Typical lithium salt concentration range from about 0.1 to about 2.0 M.

Exemplary sultone additives include those represented by Formula 1:

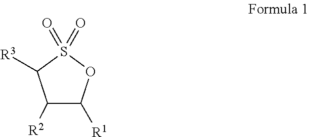

where R¹, R², and R³ each are independently selected from the group consisting of hydrogen, halogen, an alkyl group having 1 to 3 carbon atoms, and a halogenated alkyl group having 1 to 3 carbon atoms. Preferred to be used is one or more sultones selected from 1,3-propane sultone (PS), 1-methyl-1,3-propane sultone, 2-methyl-1,3-propane sultone, 3-methyl-1,3-propane sultone, 1-ethyl-1,3-propane sultone, 2-ethyl-1,3-propane sultone, 3-ethyl-1,3-propane sultone, 1,2-dimethyl-1,3-propane sultone, 1,3-dimethyl-1,3-propane sultone, 2,3-dimethyl-1,3-propane sultone, 1-methyl-2-ethyl-1,3-propane sultone, 1-methyl-3-ethyl-1,3-propane sultone, 2-methyl-3-ethyl-1,3-propane sultone, 1-ethyl-2-methyl-1,3-propane sultone, 1-ethyl-3-methyl-1,3-propane sultone, 2-ethyl-3-methyl-1,3-propane sultone, 1-fluoromethyl-1,3-propane sultone, 2-fluoromethyl-1,3-propane sultone, 3-fluoromethyl-1,3-propane sultone, 1-trifluoromethyl-1,3-propane sultone, 2-trifluoromethyl-1,3-propane sultone, 3-trifluoromethyl-1,3-propane sultone, 1-fluoro-1,3-propane sultone, 2-fluoro-1,3-propane sultone, 3-fluoro-1,3-propane sultone, 1,2-difluoro-1,3-propane sultone, 1,3-difluoro-1,3-propane sultone, and 2,3-difluoro-1,3-propane sultone. Among them, PS is particularly preferred because of its small molecular size. The specific amount of the sultone additive may vary depending on the application at hand, but is preferably from about 0.05 wt % to about 2 wt %, based on the total weight of the electrolyte. In some embodiments, the sultone concentration is from about 0.5 wt % to about 1.5 wt %, and in additional embodiments is from about 0.8 wt % to 1.2 wt %.

In addition to sultones, other additives may be included in the electrochemical cell to further improve and/or preserve its performance. For instance, additives preserving the cell from high temperature-induced performance deterioration may be added to the electrolyte in instances where the cell is likely to be operated or stored under conditions where relatively high temperatures may be reached. Exemplary among such high temperature performance electrolyte additives are lithium imide salts, in particular lithium imide salts with fluoroalkylsulfone side chains. Typical compounds belonging to this class are imide salts represented by formula LiN(CₓF₂ₓ₊₁SO₂)(CyF_{2y+1}SO₂), where x and y each are natural numbers from 1 to 5; commonly used imide lithium salts include LiN(CF₃SO₂)₂ (LiTFSI) and LiN(C₂F₅SO₂)₂ (LiBETl). As is the case for the sultone additive, the concentration of the high temperature performance additive may vary, but concentration ranges from about 0.05 wt % to about 3 wt %, based on the total weight of the electrolyte, are preferred. In some embodiments, the high temperature performance additive concentration is from about 0.1 wt % to about 1.5 wt %, based on the total weight of the electrolyte. In further embodiments, the concentration is from about 0.2 wt % to about 0.8 wt %.

A method of producing an electrochemical cell will now be described. First, a cathode active material, a conducting agent, a binder, and a solvent are mixed to prepare a cathode composition. The cathode active material may include one of the stabilized lithium metal oxide materials or a traditional LiMO₂ material such as those described hereinabove. The cathode composition can be coated directly on a current collector and dried to prepare a cathode plate. Alternatively, the composition can be cast on a separate support to form a cathode composition film, which film is then peeled from the separate support and laminated on a current collector to prepare a positive electrode plate. One commonly used conducting agent is carbon black. Examples binders include vinylidene fluoride/hexafluoropropylene copolymers, polyvinylidenefluoride (PVDF), polyacrylonitrile, polymethylmethacrylate, polytetrafluoroethylene, and combinations thereof. The binder may also be a styrene butadiene rubber-based polymer. Example solvents include N-methylpyrrolidone (NMP), acetone, water, and the like.

Then, an anode active material, a conducting agent, a binder, and a solvent are mixed to prepare an anode composition. The anode composition can be coated directly on a current collector to obtain an anode plate. Alternatively, the anode composition can be cast on a separate support to form an anode composition film, which film is then peeled from the separate support and laminated on a current collector to obtain a negative electrode plate.

Non-limiting examples of suitable anode active materials include lithium metal, lithium alloys, and carbonaceous materials (such as graphite). In the anode composition, the conducting agent, the binder, and the solvent may be the same as used in the cathode. In some cases, a plasticizer may be added to the cathode active material composition and the anode active material composition to form pores in the electrode plates.

The cathode and the anode are usually separated by a separator. The separator can be any separator that is commonly used in lithium batteries. A suitable separator may have low resistance to ion movement of the electrolyte and high electrolyte retaining capability. Non-limiting examples of suitable separators include glass fibers, polyester, teflon, polyethylene, polypropylene, polytetrafluoroethylene (PTFE) and combinations thereof, each of which can be a woven or non-woven fabric. Foldable separators formed of polyethylene or polypropylene can be used in lithium ion batteries. On the other hand, separators having high organic electrolyte retaining capabilities can be used in lithium ion polymer batteries. An example method of preparing a separator will now be described.

A polymer resin, a filler, and a solvent are mixed to prepare a separator composition. The separator composition can be coated directly on an electrode and dried to form a separator film. Alternatively, the separator composition can be cast on a support and dried to form a separator composition film, which film is then peeled from the separate support and laminated on an electrode. The polymer resin is not limited and can be any material used as a binder for an electrode plate. Non-limiting examples of suitable polymer resins include vinylidenefluoride/hexafluoropropylene copolymers, polyvinylidenefluoride, polyacrylonitrile, polymethylmethacrylate, and combinations thereof.

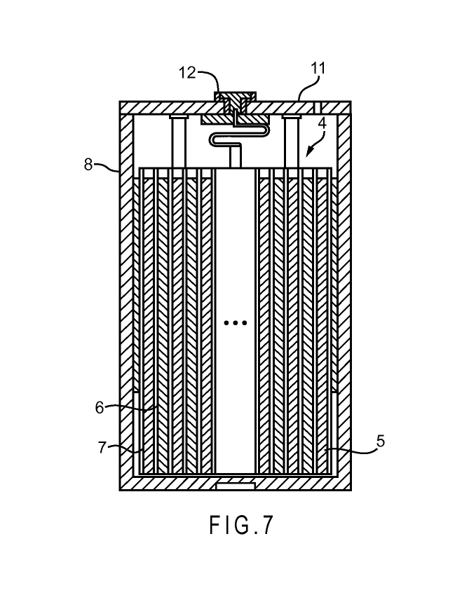

As shown in FIG. 7, an example lithium battery 3 includes an electrode assembly 4 which includes a positive electrode 5, negative electrode 6 and a separator 7 between the cathode 5 and anode 6. The electrode assembly 4 is enclosed in a battery case 8, which is sealed with a cap plate 11 and gasket 12. An organic electrolyte is then injected into the battery to complete a lithium ion battery. Alternatively, the battery assembly can be stacked to form a bi-cell structure, and then impregnated with an organic electrolyte. The obtained product is then placed in a pouch and sealed, thus completing a lithium ion polymer battery.

A plurality of battery assemblies or batteries may be stacked to form a battery pack, which may be used in any device that operates at high temperatures and requires high output, e.g., in a laptop computer, a smart phone, electric vehicle, and the like. The lithium battery may have high discharge capacity and improved high rate characteristics, and thus may be applicable in an electric vehicle (EV), e.g., in a hybrid vehicle or a plug-in hybrid electric vehicle (PHEV). The lithium battery may be applicable to a high-power storage field, e.g., in an electric bicycle, a power tool, or the like.

### Examples

### Materials and Methods

Coin cells were prepared, as follows. A 9/16″ graphite negative electrode was placed on top of a 0.5 mm-thick spacer which was placed on a Belleville washer. Electrolyte was added dropwise to the negative electrode to wet its surface, and a polyethylene separator having a thickness of 20 μm was placed on top of the wet negative electrode. More electrolyte drops were added to the negative electrode-separator assembly, and a ½″ positive electrode was laid on top of the separator. A spacer having a thickness of 1 mm was placed on top of the positive electrode and the resulting cell was capped and crimped with a manual crimper. The reference, baseline electrolyte was prepared by dissolving 1 M LiPF₆ in a 1:1 (vol/vol) mixture of ethyl carbonate and ethyl methyl carbonate.

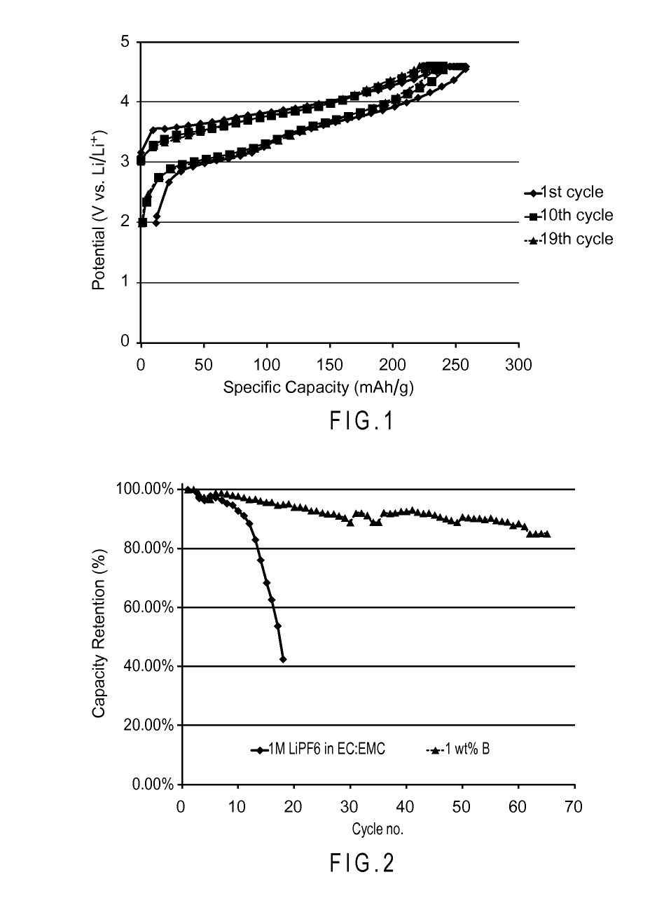

FIG. 1 shows the half cell voltage curves of LiMnO₂.Li₂MnO₃ tested in the reference electrolyte with 1 wt % 1,3-propane sultone, based on the total weight of the electrolyte. As summarized in Table 1, the first cycle irreversible loss was 10% with a specific reversible capacity of over 250 mAh/g. The stability of the electrolyte was evinced in the stability of DC pulse impedance after the tenth cycle as well as the slow capacity fading, as shown in FIG. 2. By only using an electrolyte consisting of carbonate solvents (baseline), the cell could not cycle beyond ten cycles, which, while not being bound to any particular theory, was believed to be due to the oxidative side reactions between the electrolyte and the cathode.

TABLE 1
Properties of LiMO₂•Li₂MnO₃ as cathode material using 1
wt % 1,3-propane sultone as electrolyte additive - half cell data

| First charge capacity | 3.24 | mAh |
|---|---|---|
| First discharge capacity | 2.92 | mAh |
| % irreversible loss | 10.0% | |
| Specific reversible | 268.2 | mAh/g |
| Pulse impedance, first charge | 15 | Ω |
| Pulse impedance, tenth charge | 16 | Ω |

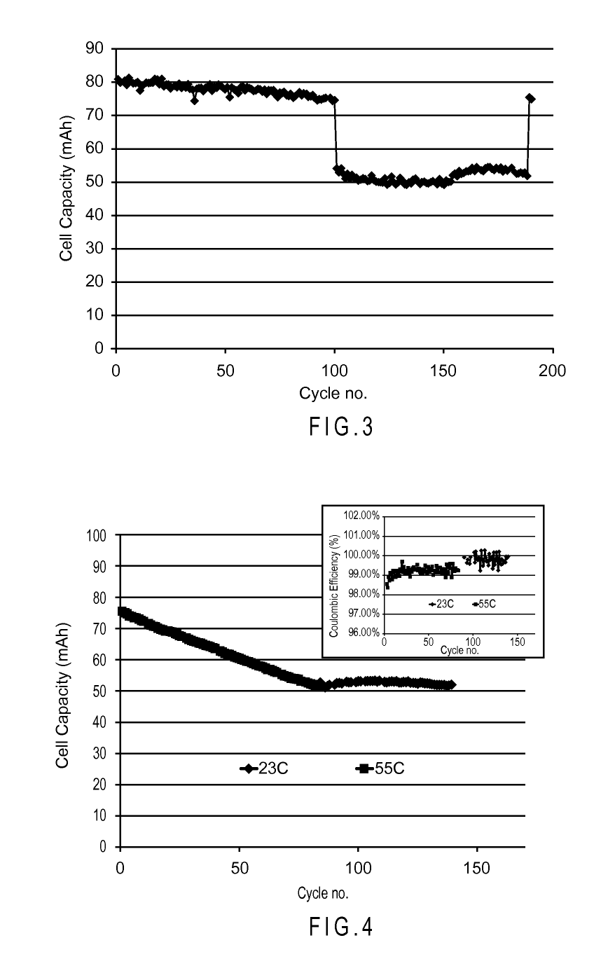

The stability of the electrolyte containing the sultone additive was also demonstrated in a full cell, as shown in FIG. 3. The capacity fading of a 110 mAh cell was less than 3% over 100 cycles at a charge/discharge rate of 1C. Lower capacities were observed at higher rates, which was likely due to higher impedance since the capacity recovered back to the lower rate value. Notably, the capacity fading was noticed at all tested rates, as illustrated in FIG. 3.

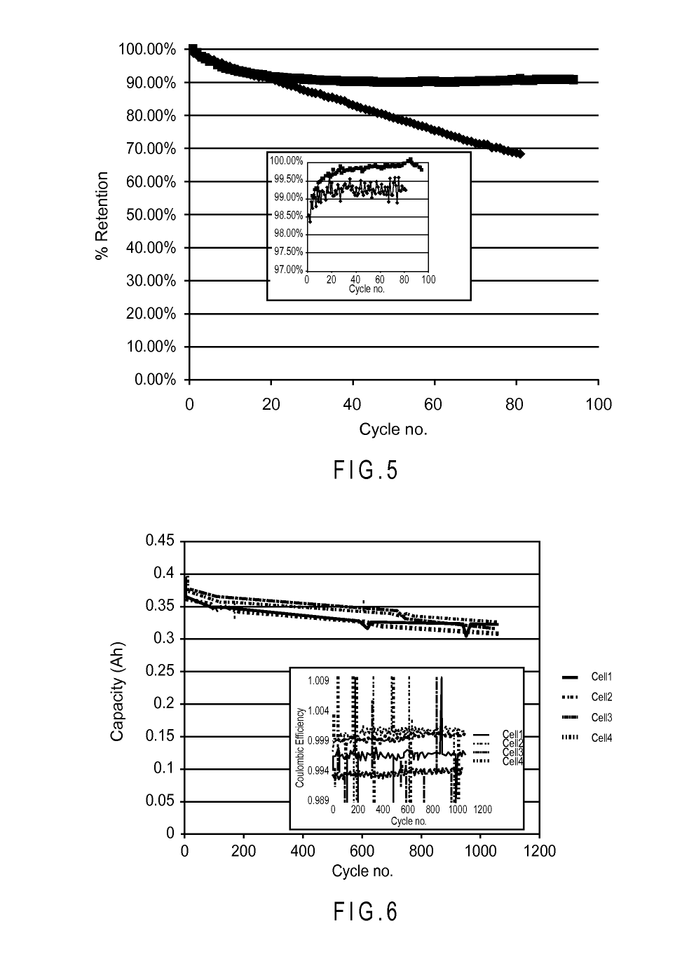

Temperature studies were also performed. It was observed that the capacity fading was quite severe in just a hundred cycles at 55° C. Without wishing to be bound to any particular theory, this fading was likely due to the loss of lithium active material. Coulombic efficiency proved to be poor at 55° C. relative to 23° C., as shown in the inset of FIG. 4. To address this, electrolyte additives for improved high temperature performance were tested. In particular, lithium bistrifluoromethylsulfonimide (LiTFSI), a fluorimide salt, was used as an additive in the amount of 0.5% by weight, based on the total weight of the electrolyte. FIG. 5 shows the significant improvement when the LiTFSI additive was used. Other types of additives, including those bearing an oxalate group, e.g. LiBOB (lithium bisoxalato borate), and those bearing an unsaturated carbon-carbon double bond, e.g. vinylene carbonate (VC) were also found to help maintain high temperature stability (data not shown).

Studies were also carried out with traditional LiMO₂ cathode materials being charged at voltages higher than 4.3V vs. Li, including experiments on NMC cathodes in the presence of electrolyte formulations including a mixture of carbonate solvents and additives within the range of 0.01 wt % to 10% wt %, based on the total weight of the electrolyte. FIG. 6 illustrates the performance of four cells featuring an NMC cathode and an electrolyte containing 1 wt % vinylene carbonate, 1 wt % 1,3-propane sultone, and 0.5 wt % LiBOB. As shown by the plots of the figure, the performance of this type of cell proved to be highly reproducible.

It is important to note that the construction and arrangement of electrodes and electrochemical cells as shown in the examples above is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

Furthermore, the technical effects and technical problems in the present specification are exemplary and not limiting. It should be noted that the embodiments described in the present specification may have other technical effects and can solve other technical problems.

1. An electrochemical cell provided with a positive electrode, a negative electrode, and an electrolyte, where:
the positive electrode comprises a stabilized lithium metal oxide material, the lithium metal oxide material comprising one or more transition metal ions; and
the electrolyte is prepared by mixing ingredients comprising a solvent, a lithium salt, and a sultone.

2. The electrochemical cell of claim 1, where the stabilized lithium metal oxide material in its initial discharged state is represented by formula xLiMO₂.(1-x)Li₂M′O₃, where 0<x<1, M is one or more ions having an average oxidation state of three with at least one ion being Mn, and M′ is one or more ions having an oxidation state of four and selected from Mn, Ti, and Zr.

3. The electrochemical cell of claim 1, where the stabilized lithium metal oxide material in its initial discharged state is represented by formula xLiMO₂.(1-x)Li₂M′O₃, where 0<x<1, M is one or more ions having an average oxidation state of three with at least one ion being Ni, and M′ is one or more ions having an average oxidation state of four with at least one ion being Mn.

4. The electrochemical cell of claim 1, where the sultone is represented by Formula 1: 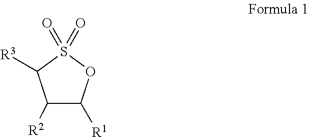
where R₁, R₂, and R₃ each are independently selected from the group consisting of hydrogen, halogen, an alkyl group having 1 to 3 carbon atoms, and a halogenated alkyl group having 1 to 3 carbon atoms.

5. The electrochemical cell of claim 1, where the sultone is selected from the group consisting of 1,3-propane sultone, 1-methyl-1,3-propane sultone, 2-methyl-1,3-propane sultone, 3-methyl-1,3-propane sultone, 1-ethyl-1,3-propane sultone, 2-ethyl-1,3-propane sultone, 3-ethyl-1,3-propane sultone, 1,2-dimethyl-1,3-propane sultone, 1,3-dimethyl-1,3-propane sultone, 2,3-dimethyl-1,3-propane sultone, 1-methyl-2-ethyl-1,3-propane sultone, 1-methyl-3-ethyl-1,3-propane sultone, 2-methyl-3-ethyl-1,3-propane sultone, 1-ethyl-2-methyl-1,3-propane sultone, 1-ethyl-3-methyl-1,3-propane sultone, 2-ethyl-3-methyl-1,3-propane sultone, 1-fluoromethyl-1,3-propane sultone, 2-fluoromethyl-1,3-propane sultone, 3-fluoromethyl-1,3-propane sultone, 1-trifluoromethyl-1,3-propane sultone, 2-trifluoromethyl-1,3-propane sultone, 3-trifluoromethyl-1,3-propane sultone, 1-fluoro-1,3-propane sultone, 2-fluoro-1,3-propane sultone, 3-fluoro-1,3-propane sultone, 1,2-difluoro-1,3-propane sultone, 1,3-difluoro-1,3-propane sultone, 2,3-difluoro-1,3-propane sultone, and combinations thereof.

6. The electrochemical cell of claim 1, where the sultone is 1,3-propane sultone.

7. The electrochemical cell of claim 1, where the electrolyte sultone concentration is from 0.05 wt % to about 2 wt %, based on the total weight of the electrolyte.

8. The electrochemical cell of claim 1, where the solvent is selected from the group consisting of dimethyl carbonate, ethyl methyl carbonate, diethyl carbonate, dipropyl carbonate, methylpropyl carbonate, ethylpropyl carbonate, ethylene carbonate, propylene carbonate, butylene carbonate, and combinations thereof.

9. The electrochemical cell of claim 1, where the solvent comprises ethylene carbonate and ethyl methyl carbonate.

10. The electrochemical cell of claim 1, where the lithium salt is selected from the group consisting of LiPF₆, LiBF₄, LiSbF₆, LiAsF₆, LiClO₄, LiCF₃SO₃, LiC₄F₉SO₃, LiSbF₆, LiAlO₄, LiAlCl₄, LiCl, LiI, and combinations thereof.

11. The electrochemical cell of claim 1, where the lithium salt is LiPF₆.

12. The electrochemical cell of claim 1, the electrolyte ingredients further comprising a high temperature performance additive.

13. The electrochemical cell of claim 1, the electrolyte ingredients further comprising bis(trifluoromethanesulfonyl)imide.

14. An electrochemical cell comprising:
an electrode comprising a material represented by formula LiMO₂, where M includes one or more transition metal ions; and
an electrolyte formed from ingredients comprising a solvent, a lithium salt, and sultone; and
a negative electrode.

15. The electrochemical cell of claim 14, where M includes one or more ions having an average oxidation state of three with at least one ion being Mn.

16. The electrochemical cell of claim 14, where the material represented by formula LiMO₂ is LiMnO₂.

17. The electrochemical cell of claim 14, where the sultone is represented by Formula 1: 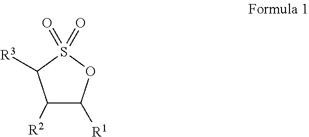
where R₁, R₂, and R₃ each are independently selected from the group consisting of hydrogen, halogen, an alkyl group having 1 to 3 carbon atoms, and a halogenated alkyl group having 1 to 3 carbon atoms.

18. The electrochemical cell of claim 14, where the sultone is selected from the group consisting of 1,3-propane sultone, 1-methyl-1,3-propane sultone, 2-methyl-1,3-propane sultone, 3-methyl-1,3-propane sultone, 1-ethyl-1,3-propane sultone, 2-ethyl-1,3-propane sultone, 3-ethyl-1,3-propane sultone, 1,2-dimethyl-1,3-propane sultone, 1,3-dimethyl-1,3-propane sultone, 2,3-dimethyl-1,3-propane sultone, 1-methyl-2-ethyl-1,3-propane sultone, 1-methyl-3-ethyl-1,3-propane sultone, 2-methyl-3-ethyl-1,3-propane sultone, 1-ethyl-2-methyl-1,3-propane sultone, 1-ethyl-3-methyl-1,3-propane sultone, 2-ethyl-3-methyl-1,3-propane sultone, 1-fluoromethyl-1,3-propane sultone, 2-fluoromethyl-1,3-propane sultone, 3-fluoromethyl-1,3-propane sultone, 1-trifluoromethyl-1,3-propane sultone, 2-trifluoromethyl-1,3-propane sultone, 3-trifluoromethyl-1,3-propane sultone, 1-fluoro-1,3-propane sultone, 2-fluoro-1,3-propane sultone, 3-fluoro-1,3-propane sultone, 1,2-difluoro-1,3-propane sultone, 1,3-difluoro-1,3-propane sultone, 2,3-difluoro-1,3-propane sultone, and combinations thereof.

19. The electrochemical cell of claim 14, where the sultone is 1,3-propane sultone.

20. The electrochemical cell of claim 14, where the electrolyte sultone concentration is from 0.05 wt % to about 2 wt %, based on the total weight of the electrolyte.

21. The electrochemical cell of claim 14, where the solvent is selected from the group consisting of dimethyl carbonate, ethyl methyl carbonate, diethyl carbonate, dipropyl carbonate, methylpropyl carbonate, ethylpropyl carbonate, ethylene carbonate, propylene carbonate, butylene carbonate, and combinations thereof.

22. The electrochemical cell of claim 14, where the solvent comprises ethylene carbonate and ethyl methyl carbonate.

23. The electrochemical cell of claim 14, where the lithium salt is selected from the group consisting of LiPF₆, LiBF₄, LiSbF₆, LiAsF₆, LiClO₄, LiCF₃SO₃, LiC₄F₉SO₃, LiSbF₆, LiAlO₄, LiAlCl₄, LiCl, LiI, and combinations thereof.

24. The electrochemical cell of claim 14, where the lithium salt is LiPF₆.

25. The electrochemical cell of claim 14, the electrolyte ingredients further comprising a high temperature performance additive.

26. The electrochemical cell of claim 14, the electrolyte ingredients further comprising bis(trifluoromethanesulfonyl)imide.

27-28. (canceled)

29. A vehicle comprising the electrochemical cell of claim 1.

30. A vehicle comprising the electrochemical cell of claim 14.

31. A car battery comprising the electrochemical cell of claim 1.

32. A car battery comprising the electrochemical cell of claim 14.
